(19) United States
(12) Patent Application Publication
(10) Pub. No.: US 2013/0036059 A1
(43) Pub. Date: Feb. 7, 2013

(54) ELECTRONIC PRICE-PROPOSING SYSTEM, ELECTRONIC PRICE-PROPOSING DEVICE, AND ELECTRONIC PRICE-PROPOSING METHOD

(71) Applicants: Yuuji Oura, Tokyo (JP); Ken Umeno, Tokyo (JP)

(72) Inventors: Yuuji Oura, Tokyo (JP); Ken Umeno, Tokyo (JP)

(73) Assignee: PATENET CORPORATION, Tokyo (JP)

(21) Appl. No.: 13/366,360

(22) Filed: Feb. 6, 2012

(30) Foreign Application Priority Data
Aug. 5, 2009 (JP) 2009-182177
Aug. 3, 2010 (JP) PCT/JP2010/063093

(51) Int. Cl. G06Q 20/40

(52) U.S. Cl. 705/71

(57) ABSTRACT

An electronic price-proposing server is provided with: a secret-key recording means for recording identification codes assigned individually to multiple user terminals and calculation values thereof, in association with each of the users as secret keys thereof, an encrypting means for generating encryption data with the chaotic encryption method, a price-data recording means for recording the encryption data in association with the corresponding item and user, a searching means for searching for and reading encryption data corresponding to requests from user terminals, and a transmitting means for transmitting the result thereof to the user terminals. Meanwhile, the user terminals are provided with: a decrypting means for decrypting the received encrypted data, using an identification-code value read out from an identification-code value reading means, and generating the original price data, and a displaying means for displaying the decrypted price data.

### CROSS REFERENCE TO RELATED APPLICATION

This application claims the benefit of PCT Application Serial Number PCT/JP2010/063093 filed Aug. 3, 2010 and claims the benefit of Japan application Serial Number 2009-182177 filed on Aug. 5, 2009 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to an electronic price-proposing system and a device and a method of the same and relates to a technology in which different price lists are presented to each customer and information is kept secret so that a sales price is not known to a third party.

2. Description of Related Art Including Information Disclosed Under 37 CFR 1.97 and 1.98

In many cases, a price of an item such as a goods or service is individually set for each business partner in a distribution process. The price of an item set as above is referred to as a party price. The party price needs to be kept secret to third parties other than the business partner for the interest of the deal. Thus, a price list of items has been prepared individually for each business partner and the price list printed on paper has been presented only to the corresponding business partner so that the price of the item is not known to third parties.

A technology of ensuring secrecy to a third party while a price is easily proposed to a business partner is proposed in Patent Literature 1 by the applicant of this case. According to this technology, encryption is executed by using a secret key corresponding to a user of a client by a chaotic encryption method in an electronic price-proposing server, and the client executes decrypting by using the secret key of the user to display the price list. As a result, the user can display price list with little labor while keeping high level of security.

However, the above-described technology cannot fully handle problems by a method using a mobile phone, which has been on an increase. The problems include those specific to mobile terminals such as necessity of decrypting on the terminal side, labor required in a communication access to the electronic price list, a transmission method of a secret key and the like, for example.

### CITATION LIST

### Patent Literature

Patent Literature 1: Japanese Patent No. 4219629

### SUMMARY OF INVENTION

### Technical Problem

The present invention was made in view of the problems of the prior-art technology and has an object to provide an electronic price-proposing system, a device, and a method which can obtain price information easily by a mobile terminal device such as a mobile phone when a price is electronically proposed by a chaotic encryption method.

### Solution to Problem

In order to solve the above problems, the present invention provides the following electronic price-proposing system.

That is, the present invention is an electronic price-proposing system composed of a user terminal held by each of a plurality of users and an electronic price-proposing server which proposes a price corresponding to each user, and is provided with the following configuration.

First, the electronic price-proposing server includes secret-key recording means which records an identification code value which is either of identification code assigned uniquely to each of a plurality of user terminals or a calculation value calculated in accordance with a predetermined calculation formula from the identification code in association as a secret key of each user, encrypting means which generates encrypted data by a chaotic encryption method, price data recording means which records the encrypted data in association with the corresponding item and user, search means which searches and reads out the encrypted data recorded in association with the user from the price data recording means in accordance with a request from a user terminal, and transmitting means which transmits the encrypted data read out by the search means to the user terminal.

### BRIEF SUMMARY OF THE INVENTION

The encrypting means of the present invention is characterized in that M pieces of the secret key associated with each user are read out from the secret-key recording means and N pieces of the price data with respect to each item is encrypted as one N-dimensional vector to generate the encrypted data by a chaotic encryption method in which N-dimensional (N is a natural number) rational number vectors are encrypted at the same time by using M pieces (M is a natural number) secret keys.

On the other hand, the user terminal includes identification code value reading means which reads out or calculates the identification code value, second transmitting means which transmits the request to the electronic price-proposing server, receiving means which receives the encrypted data transmitted from the electronic price-proposing server, decrypting means which decrypts the received encrypted data by using the identification code value read out of the identification code value reading means and generates the original price data, and display means which displays the decrypted price data.

Alternatively, the configuration may be as follows.

That is, the electronic price-proposing server of the present invention includes decrypting means which decrypts the encrypted data read out by the search means by using the identification code value of the user read out of the secret-key recording means and transmitting means which transmits the decrypted price data to the user terminal in addition to the secret-key recording means, the encrypting means, the price data recording means, and the search means which searches and reads out the encrypted data recorded in association with the user from the price data recording means in accordance with the request from the user terminal.

The user terminal includes receiving means which receives the price data transmitted from the electronic price-proposing server and display means which displays the received price data in addition to the second transmitting means.

The above-described electronic price-proposing system may be configured such that, after lossless compressing N pieces of the price data with respect to each item to one N-dimensional vector, the encrypting means of the electronic price-proposing server encrypts the data as the N-dimensional vector and generates encrypted data, while the decrypting means of the user terminal performs an operation opposite to the lossless compression after decryption and generates the original price data.

In the above-described electronic price-proposing system, it may be so configured that hash means which obtains and records N pieces of hash values by hashing the N-dimensional encrypted data encrypted by encrypting means of the electronic price-proposing server by a predetermined hash function is provided so that the search means of the electronic price-proposing server searches and reads out the encrypted data recorded in association with the user from the price data recording means in accordance with the request from the user terminal by using the hash value recorded in association with the user as a keyword.

In the above-described electronic price-proposing system, price link means including at least information of a network address of the electronic price-proposing server and an item identification code for identifying an item can be used. This price link means should be electronically readable by the user terminal.

In response to that, the user terminal is provided with price link reading means for reading the price link means and sends the read-out item identification code to the read-out network address from the second transmitting means. Moreover, the search means of the electronic price-proposing server searches the encrypted data including the price of the item corresponding to the received item identification code.

In the above-described electronic price-proposing system, the second transmitting means transmits a price conversion value for updating the price in the price data together with the read-out item identification code, and the electronic price-proposing server can be provided with price updating means for updating the price data with a result calculated on the basis of the price conversion value.

It may be so configured that the above-described price link means is barcode information and the price link reading means is a sensor for reading the barcode.

Alternatively, it may be configured that the price link means is a non-contact tag and the price link reading means is non-contact type reading means.

In the electronic price-proposing server of the present invention, input means for inputting a batch price conversion value for updating the price in the price data in a batch and batch price updating means for updating the price data with a result calculated on the basis of the batch price conversion value may be provided.

This batch price updating means may be configured to record an original price before update together with the updated price at the same time.

The present invention can be provided as an electronic price proposing device provided with the configuration of the above-described electronic price-proposing server.

In this device, in the configuration of decryption to the price data, not only the transmitting means for transmitting the decrypted price data to the user terminal but also display means for displaying the decrypted price data may be provided.

The present invention may be provided as a processing method in an electronic price-proposing system composed of a user terminal, each held by a plurality of users and an electronic price-proposing server which proposes a price corresponding to each user.

That is, an identification code value which is either of an identification code uniquely assigned to each of the plurality of user terminals in advance or a calculated value calculated in accordance with a predetermined calculation formula from the identification code is associated as a secret key of each user and recorded in the secret-key recording means of the electronic price-proposing server, and there are provided:

(A) an encryption step in which the encrypting means of the electronic price-proposing server reads out M pieces of the secret keys associated with each of the users from the secret-key recording means and encrypts N pieces of the price data to each of the items as a single N-dimensional vector so as to generate encrypted data by the chaotic encryption method of encrypting an N-dimensional (N is a natural number) rational number vector in a batch by using the M (M is a natural number) pieces of the secret keys;

(B) a price data recording step in which the price data recording means of the electronic price-proposing server records the encrypted data in association with the corresponding item and the user;

(C) a request transmission step in which the second transmitting means of the user terminal transmits a request to the electronic price-proposing server;

(D) a search step in which the search means of the electronic price-proposing server searches and reads out the encrypted data recorded in association with the user from the price data recording means in accordance with the request from the user terminal;

(E) a transmission step in which the encrypted data read out by this search means is transmitted to the user terminal;

(F) a reception step in which the receiving means of the user terminal receives the encrypted data transmitted from the electronic price-proposing server;

(G) an identification code value read-out step in which the identification code value reading means of the user terminal reads out or calculates the identification code value;

(H) a decryption step in which the decrypting means of the user terminal decrypts the received encrypted data by using the identification code value read out of the identification code value reading means and generates the original price data; and

(I) a display step in which the display means of the user terminal displays the decrypted price data.

The present invention can provide the following processing method in the electronic price-proposing system.

That is, an identification code value which is either of an identification code uniquely assigned to each of the plurality of user terminals in advance or a calculated value calculated in accordance with a predetermined calculation formula from the identification code is associated as a secret key of each user and recorded in the secret-key recording means of the electronic price-proposing server, and there are provided:

(a) an encryption step in which the encrypting means of the electronic price-proposing server reads out M pieces of the secret keys associated with each of the users from the secret-key recording means and encrypts N pieces of the price data to each of the items as a single N-dimensional vector so as to generate encrypted data by using the chaotic encryption method of encrypting an N-dimensional (N is a natural number) rational number vector in a batch by using the M (M is a natural number) pieces of the secret keys;

(b) a price data recording step in which the price data recording means of the electronic price-proposing server records the encrypted data in association with the corresponding item and the user;

(c) a request transmission step in which the second transmitting means of the user terminal transmits a request to the electronic price-proposing server;

(d) a search step in which the search means of the electronic price-proposing server searches and reads out the encrypted data recorded in association with the user from the price data recording means in accordance with the request from the user terminal;

(e) a decryption step in which the decrypting means of the electronic price-proposing server decrypts the encrypted data read out by this search means by using the identification code value of the user read out from the secret-key recording means;

(f) a transmission step in which the transmitting means of the electronic price-proposing server transmits the decrypted price data to the user terminal;

(g) a reception step in which the receiving means of the user terminal receives the price data transmitted from the electronic price-proposing server; and

(h) a display step in which the display means of the user terminal displays the price data.

In the encryption step (A) or (a) in either of the above-described electronic price-proposing methods, after lossless compressing N pieces of the price data with respect to each item to one N-dimensional vector, the encrypting means of the electronic price-proposing server encrypts the data as the N-dimensional vector and generates encrypted data, and in the decryption step (H) or (e), the decrypting means of the user terminal executes decryption and then, performs an operation opposite to the lossless compression and can generate the original price data.

In either of the above-described electronic price-proposing methods, it may be so configured that a hashing step in which hashing means of the electronic price-proposing server hashes the N-dimensional encrypted data encrypted in the encryption step by a predetermined hash function so as to obtain and record N pieces of hash values is provided subsequent to the encryption step (A) or (a) and in the search step, the search means of the electronic price-proposing server searches and reads out the encrypted data recorded in association with the user from the price data recording means in accordance with the request from the user terminal by using the hash value recorded in association with the user as a keyword.

The present invention can be provided as a program for a server, characterized in that either of the above-described electronic price-proposing methods is executed by the electronic price-proposing server of a computer.

Moreover, the present invention can be provided as a program for a terminal, characterized in that either of the above-described electronic price-proposing methods is executed by the user terminal of a computer.

### Advantageous Effects of Invention

The present invention exerts the following effects by including the above configuration.

A chaotic encryption method with high secrecy can be easily used since it is not necessary for a user to define a secret key by setting an identification code uniquely assigned to a user terminal or its calculation value as the secret key. Particularly, an identification code is given on hardware in the case of a mobile phone and the like, and since this information is difficult to be obtained or pretended by another terminal, erroneous presentation of the price to a person other than the user occurs extremely rarely.

Similarly, since it becomes unnecessary to generate and replace a secret key as in the prior-art technology by giving an identification code on hardware to any user terminal, it contributes to a simple electronic price-proposing method.

In a user terminal which is personally used by a user and whose communication path is also protected by a communication carrier as in mobile phone terminals, decryption is possible in the electronic price-proposing sever. In this case, processing of decryption in a user terminal is not needed, and a processing load can be reduced.

An easy access to the electronic price-proposing server from a user terminal is made possible by using the price link means of the present invention. If barcode information is displayed as the price link means next to a photo of an item in a catalog, for example, the corresponding price can be obtained from the electronic price-proposing server by reading the barcode information by the user terminal.

Moreover, if a non-contact type tag is used as the price link means, the price data can be obtained by easily accessing the electronic price-proposing server by getting the mobile phone terminal close to the non-contact type tag.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 is a block diagram illustrating a configuration example of an electronic price-proposing system in Embodiment 1 of the present invention.

FIG. 2 is a block diagram illustrating a configuration example of an electronic price-proposing server.

FIGS. 3 are diagrams illustrating an example of an electronic price data table, in which FIG. 3A illustrates a state in which an actual price between parties is displayed, and FIG. 3B illustrates a state in which the price between parties is encrypted.

FIG. 4 is a block diagram illustrating a configuration example of a database server.

FIG. 5 is a block diagram illustrating a configuration example of a Web server.

FIG. 6 is a block diagram illustrating a configuration example of a user terminal.

FIG. 7 is a flowchart illustrating a flow of processing for registering an identification code of the user terminal as a secret key.

FIG. 8 is a flowchart illustrating a flow of accumulation processing of price data in the database server.

FIG. 9 is a flowchart illustrating a flow of processing for price display at the user terminal.

FIG. 10 is a flowchart illustrating a flow of processing for price update processing at the user terminal.

FIG. 11 is an explanatory diagram when a catalog is used as an example of a medium for the electronic price-proposing system according to the present invention.

FIG. 12 is an explanatory diagram when a price tag is used as an example of a medium for the electronic price-proposing system according to the present invention.

FIG. 13 is a flowchart illustrating a flow of processing for price display in Embodiment 2 of the present invention.

FIG. 14 is a flowchart illustrating a flow of accumulation processing of price data in Embodiment 3 of the present invention.

FIG. 15 is a flowchart illustrating a flow of processing for price display in the embodiment 3 of the present invention.

FIG. 16 is a flowchart illustrating a flow of accumulation processing of price data in an embodiment 4 of the present invention.

FIG. 17 is a flowchart illustrating a flow of processing for price display in the embodiment 4 of the present invention.

FIG. 18 is a flowchart illustrating a flow of processing for batch price update in an embodiment 5 of the present invention.

### DETAILED DESCRIPTION OF THE INVENTION

Embodiments of the present invention will be described below on the basis of examples illustrated in the attached drawings. The embodiments are not limited to those below.

The present invention includes a user terminal (hereinafter referred to as a terminal) and an electronic price-proposing server (hereinafter referred to as a server) connected through a communication network such as the Internet so that prices of items accumulated in the server in the encrypted state by a chaotic encryption method can be obtained from the terminal. A method of decrypting encrypted price data at a terminal will be described in Embodiment 1 below and a method of decryption in the server in Embodiment 2, respectively.

### Embodiment 1

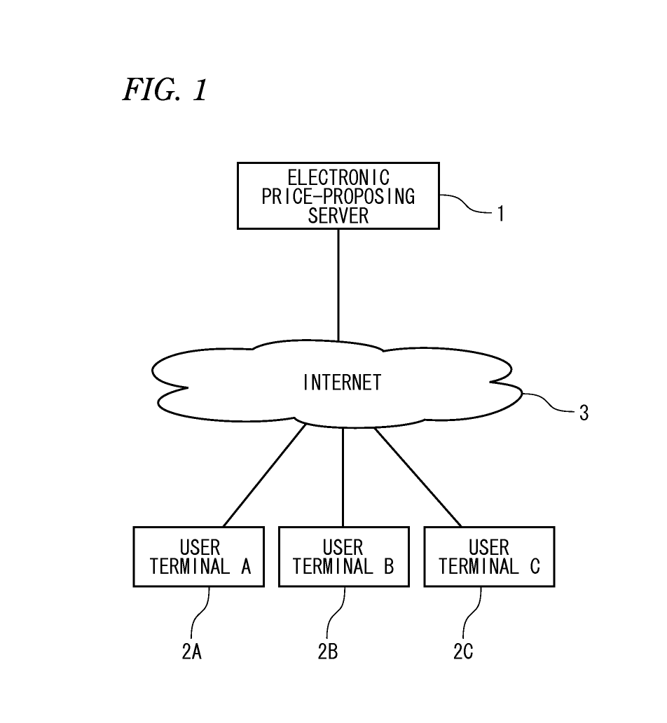

FIG. 1 is a block diagram illustrating an entire configuration of an electronic price-proposing system in Embodiment 1 of the present invention. This system includes an electronic price-proposing server (1) and user terminals (2A), (2B), and (2C) which receive service provided by this server (1) through the Internet (3). The server (1) is composed of a computer managed by a trading company, a manufacturer or the like who is an operator S on the selling side of items such as goods and services, while the terminals (2A) to (2C) are formed of mobile phone terminals of an operator and a user on the buying side of the items provided by the operator S.

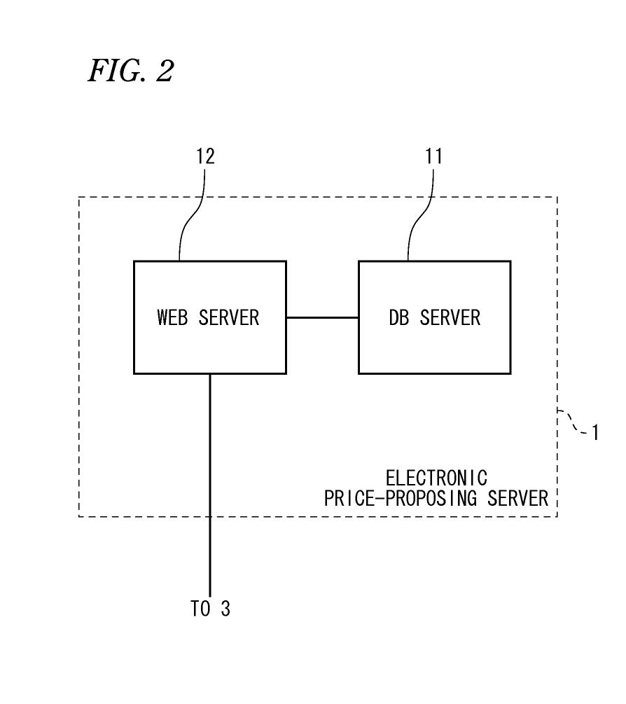

The server (1) is composed of a database server (hereinafter referred to as a “DB server”) (11) which accumulates encrypted price data of the items and can search the encrypted data in accordance with a request on the basis of this price data and a Web server (12) connected to the DB server (11) through LAN (Local Area Network) and distributes the encrypted data searched from the DB server (11) to the terminals (2A) to (2C) as illustrated in FIG. 2.

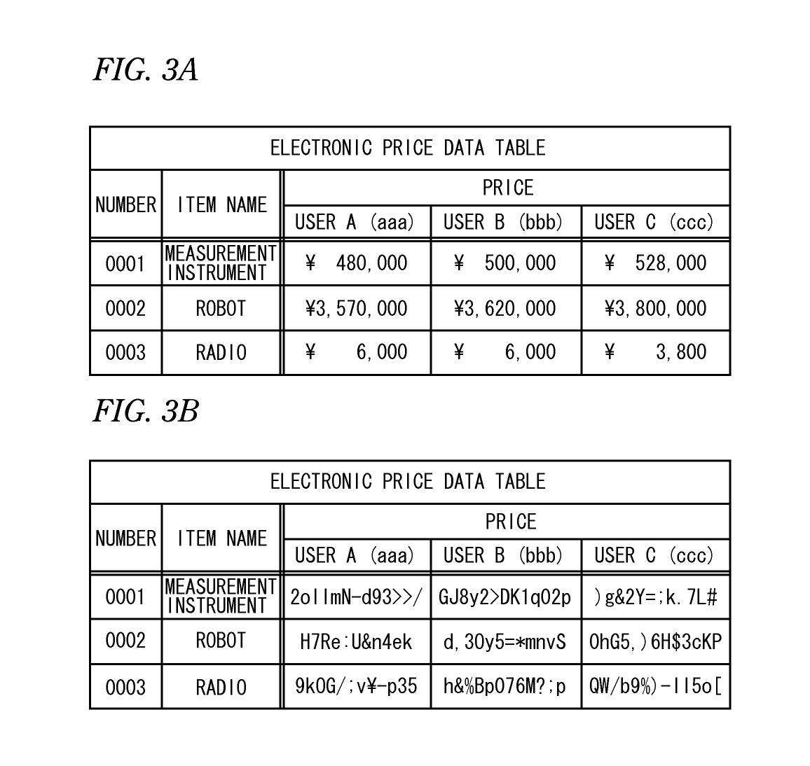

An electronic price list lists prices between parties of the items set for users A to C, who are business partners of the operator S, as illustrated in FIG. 3A, for example. The DB server (11) manages secret keys individually given to users, as will be described later, and can encrypt the prices (prices between parties) to the items for the users by using these secret keys as illustrated in FIG. 3B.

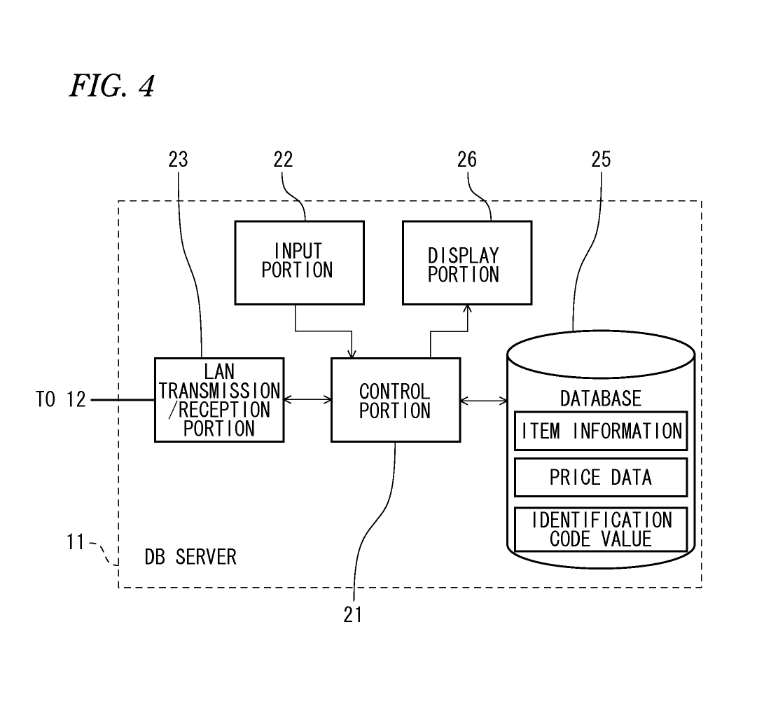

The DB server (11) has a control portion (21), an input portion (22) connected to that, a LAN transmission/reception portion (23), a database (25), and a display portion (26) as illustrated in FIG. 4.

The control portion (21) sets unique identification codes of the terminals (2A) to (2C) inputted from the input portion (22) as secret keys (KA to KC), associates the secret keys with IDs (aaa to ccc) of the users A to C and records them in the database (25).

Here, a calculation value calculated by substituting an identification code in a predetermined calculation formula provided in advice may be used as a secret key instead of using the identification code as a secret key. In the present invention, such identification code or its calculation value is referred to as an identification code value. If the identification code does not include numeral values but includes characters such as alphabets, for example, they can be converted into letter codes and digitized into decimal numbers, hexadecimal numbers, binary numbers and the like.

Moreover, the control portion (21) has encrypting means which applies encryption processing by the chaotic encryption method to the price data of the item to be offered to a user A using a secret key (a key KA, for example) corresponding to the user and records the encrypted price data (encrypted data) associated with the item number and the user ID in the database (25).

Moreover, the search means which searches the database (25) and reads out the required item information or the price data in accordance with a search instruction transmitted from the Web server (12) and inputted through the LAN transmission/reception portion (23) and the first transmitting means which transmits the item information or its encrypted data read out by the search means to the Web server (12) through the LAN transmission/reception portion (23) are provided. Since the chaotic encryption method is described in detail in Japanese Patent No. 3030341, the description will be omitted.

The input portion (22) may be configured such that input is made from the terminals (2A) to (2C) through media such as a memory card, an IC card or the like or may be such that the information transmitted from the terminals (2A) to (2C) integrated with the LAN transmission/reception portion (23) and receiving from the Web server (12) is inputted. Alternatively, the input portion may be composed of a keyboard, a touch panel or the like and used for direct input of the identification code value, input of the price between parties of the item or the like.

The LAN transmission/reception portion (23) is an interface with the LAN connected to the Web server (12).

The database (25) works as item information recording means in which the item information provided by the operator S is recorded, the secret-key recording means in which the identification code values (secret keys KA to KC) for each of the users A to C are associated with the ID (aaa to ccc) of the users A to C and recorded by the control portion (21), and the price data recording means in which the price data encrypted by the control portion (21) is associated with the item number and the user ID and recorded. Specifically, the database (25) is composed of a magnetic disk, a semiconductor memory and the like.

The display portion (26) displays the information or the like inputted from the input portion (22) to the control portion (21) on a screen.

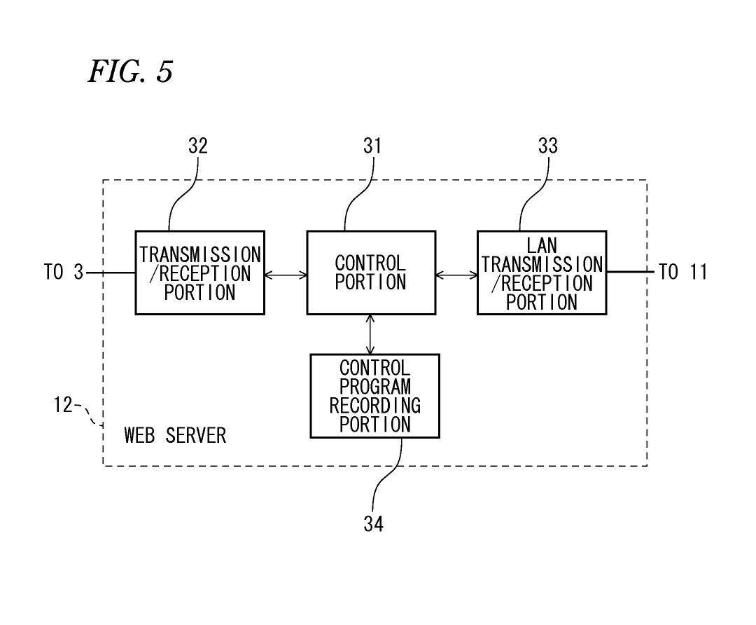

The Web server (12) has, as illustrated in FIG. 5, a control portion (31), a transmission/reception portion (32) connected to that, a LAN transmission/reception portion (33), and a control program recording portion (34).

The transmission/reception portion (32) is an interface with the Internet (3) connected to the terminals (2A) to (2C), and the LAN transmission/reception portion (33) is an interface with the LAN connected to the DB server (12).

The control program recording portion (34) records a Web server program.

The control portion (31) realizes various functions of the Web server programs recorded in the control program recording portion (34), and has means by which, if an item information display request or a price display request transmitted from the terminals (2A) to (2C) is received from the transmission/reception portion (32), an instruction to search the requested item information or price data is transmitted to the DB server (11) through the LAN transmission/reception portion (33) for example, and means by which, if the item information or price data transmitted from the DB server (11) is received by the LAN transmission/reception portion (33), HTML (HyperText Markup Language) information of the item information is generated on the basis of the item information and the price data (encrypted data) is distributed to the transmission origin of the request through the transmission/reception portion (32) as it is.

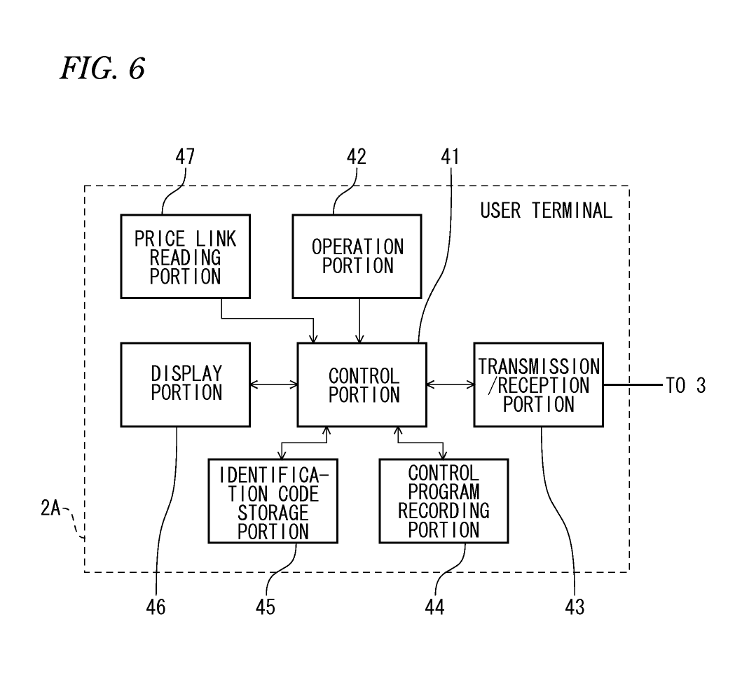

The terminal (2A) has, as illustrated in FIG. 6, a control portion (41), an operation portion (42) connected to that, a transmission/reception portion (43), a control program recording portion (44), an identification code storage portion (45), a display portion (46), and a price link reading portion (47).

The operation portion (42) is used for an operation of the terminal (2A) by the user A and specifically is composed of a keyboard, a touch panel or the like.

The transmission/reception portion (43) is an interface with the Internet (3) connected to the server (1).

The control program recoding portion (44) records a control program such as a Web browser.

The identification code storage portion (45) stores the identification code uniquely assigned to the terminal (2A) and which is recorded incapable of alteration on the hardware or software.

The display portion (46) displays information inputted from the operation portion (42) to the control portion (41) and item information and price data distributed from the server (1) on a screen.

The control portion (41) realizes various functions of the Web browser recorded in the control program recording portion (44) and has second transmitting means which transmits the item information display request, the price display request and encrypted data, which will be described later, to the server (1) through the transmission/reception portion (43) by input from the operation portion (42), for example, and analysis means which analyzes HTML information transmitted from the server (1) and inputted through the transmission/reception portion (43). Moreover, the control portion (41) has decrypting means which decrypts the encrypted price data of the electronic price list transmitted from the server (1) and inputted through the transmission/reception portion (43) by using the secret key KA recorded in the identification code storage portion (45).

Since the other terminals 2B and 2C have the similar configuration, the description will be omitted.

Subsequently, an operation of the electronic price-proposing system illustrated in FIGS. 1 to 6 will be described.

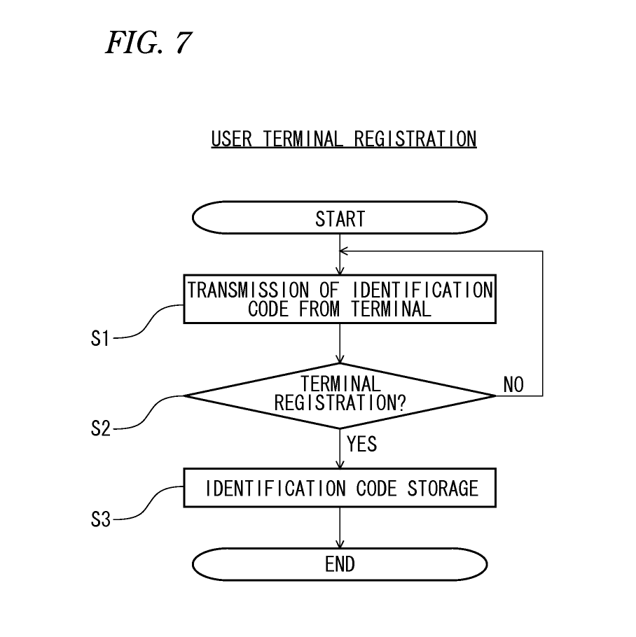

First, by referring to FIG. 7, a registration procedure of a secret key in the DB server (11) will be described. In the present invention, each user needs to register the terminal the user will use in the DB server (11) in advance. A known mobile phone terminal or a personal computer stores a serial number given to each device at manufacture, and this number is unique and cannot be altered in many cases. Particularly, the serial number is used as a method of personal authentication in a mobile phone terminal and the contents are configured to be communicated safely by mobile phone operators, and thus, it is suitable to use the numbers as secret keys of the present invention.

First, when the user instructs the terminal registration processing through an operation of the operation portion (42) by the terminal (2A), the control portion (41) reads out an identification code from the identification code storage portion (45) (S1) and transmits the identification code to the server (1) from the transmission/reception portion (43).

When the identification code reaches the control portion (21) of the DB server (11) through the Web server (12) and is determined to be terminal registration (S2), it is stored as an identification code value in the database. As the determination processing (S2) at this time, check on whether or not the user has been already registered, check on whether or not the user is in a registration refusal list, not shown, and the like may be executed.

In the present invention, the identification code and the user ID are stored in combination, but an arbitrary user ID may be inputted from the operation portion (42). In the case of a mobile phone terminal, a mobile phone number can be used as a user ID. Alternatively, a MAC address in a terminal Ethernet (registered trademark) adapter may be used as the user ID.

If there is no problem with the terminal registration, the identification code value is stored (S3). As described above, the identification code can be a calculation value calculated by a predetermined calculation formula, and in that case, the calculation value is stored (S3) after calculation processing is executed by the control portion (41).

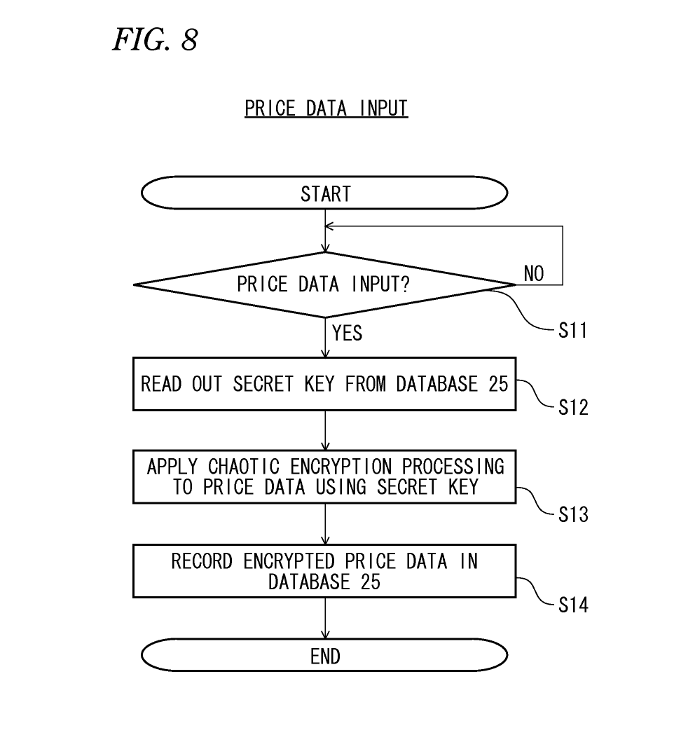

Subsequently, an accumulation procedure of the price data in the DB server (11) will be described by referring to FIGS. 8 and 3. If prices between parties of a “measurement instrument” provided to the users A to C are to be accumulated, for example, when the operator S inputs the item number “0001” and the IDs “aaa, bbb, ccc” of the users A to C and the price data “\480,000, \500,000, \528,000” indicating the prices between parties from the input portion (22) (S11: YES), the DB server (11) searches and reads out the identification code values (secret keys KA to KC) of the users A to C from the database (25) on the basis of the IDs of the users A to C (S12) by the control portion (21). Then, the encryption processing by the chaotic encryption method is applied to the inputted price data by using the read-out secret keys KA to KC, and encrypted data “2oH″mN−d93>>/, GJ8y2>DKlq02p,)g&2Y=;K.7L′#” is generated (S13). Specifically, the price data “\480,000” is encrypted by using the secret key KA, to generate the encrypted data “2oH″mN−d93>>/”, the price data “\500,000” is encrypted by using the secret key KB to generate the encrypted data “GJ8y2>DKlq02p”, and the price data “\528,000” is encrypted by using the secret key KC to generate the encrypted data “)g&2Y=;K.7L′#”. The encrypted data obtained as above is recorded in association with the item numbers and the IDs of the users A to C in the database (25) (S14), and then, accumulation of the prices between parties for the users A to C is completed.

According to the chaotic encryption method, the N-dimensional rational number vectors can be encrypted in a batch by using M pieces of the secret keys. M and N are arbitrary natural numbers. Therefore, if each row of the table is assumed to be one N-dimensional vector, the table can be encrypted for each column by using the chaotic encryption method. Moreover, the number of the columns is arbitrary, and the columns can be encrypted in a short time. Thus, each column of the users A to C in Table 3A can be encrypted in a short time by using the chaotic encryption method.

If the price between parties is to be changed in the DB server (11), the operator S inputs the item number, the operator ID and new price data together with a price data change request in the input portion (22). The DB server (11) reads out the secret key similarly to the accumulation, the encryption processing is applied to the new price data by the chaotic encryption method, and the contents of the database (25) are updated by the obtained encryption data, whereby the change of the price between parties is completed. Since the change of the price between parties can be completed easily and in a short time, price revision caused by a change in the market can be processed real time and business can be expanded advantageously.

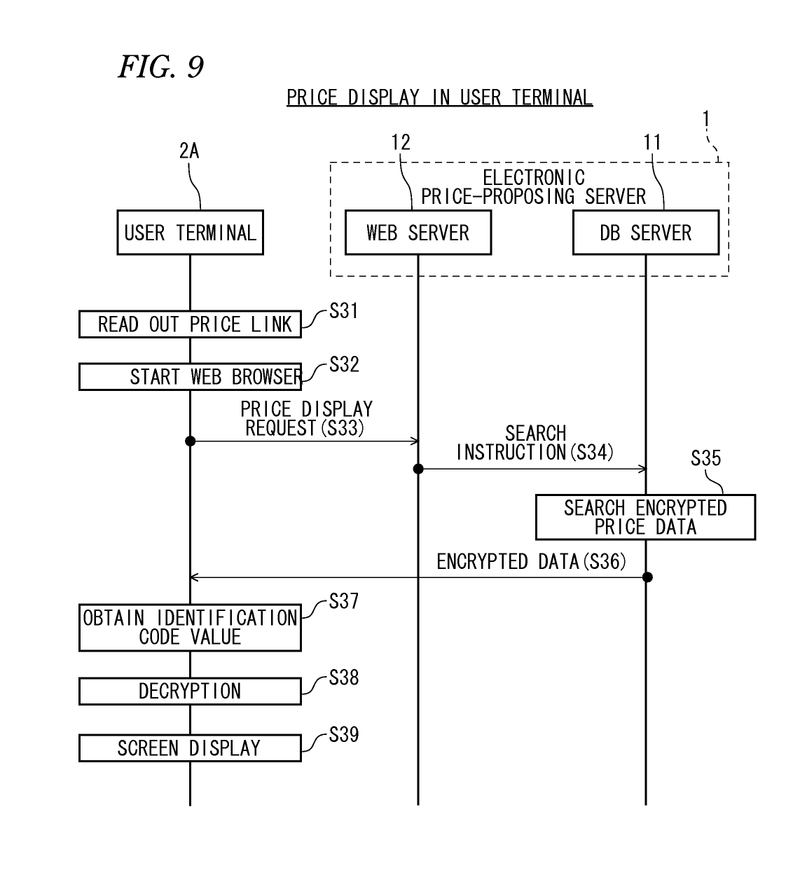

Subsequently, a display procedure of the price data in the user terminal will be described by referring to FIGS. 9, 11, and 12.

As illustrated in FIG. 9, if the user A wants to know the price of an item of the operator S, the user A first operates the operation portion (42) so as to operate the price link reading portion (47). In this embodiment, a camera provided in the mobile phone terminal and a reading device of a non-contact tag are exemplified as the price link reading portion (47), but any known means can be used as long as it is capable of electronic reading.

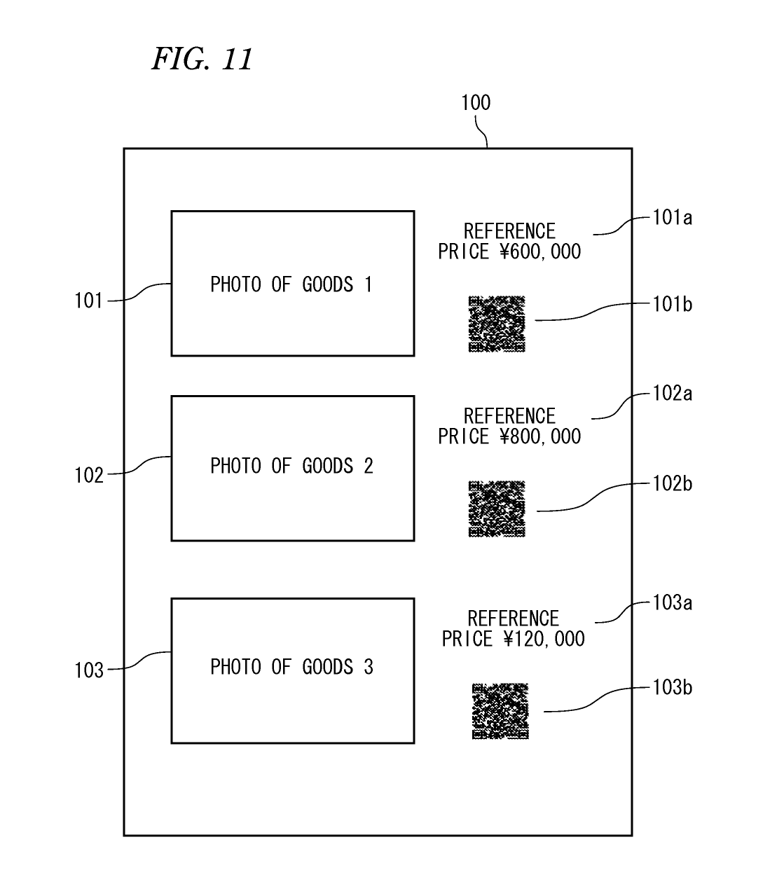

FIG. 11 is an example of a medium for an electronic price-proposing system provided with price link means. FIG. 11 illustrates a page (100) of a goods catalog in the form of a paper medium and shows photos (101), (102), and (103)of each goods similarly to a prior-art goods catalog and shows reference prices (101a), (102a), and (103a) next to them. The medium for an electronic price-proposing system of the present invention also displays two-dimensional barcodes (101b), (102b), and (103b).

This two-dimensional barcode includes information of an internet URL of the electronic price-proposing server (1) and the item identification code of each goods (a goods code, a JAN code and the like, for example).

If the user reads out the information by the price link reading portion (a camera, for example) (47), the data of the URL and the item identification code are obtained by the control portion (41) by using the known function of a mobile phone terminal (S31).

The Web browser is started (S32) when the barcode is read, and a price display request is transmitted together with the user ID and the identification code of the item to the Web server (12) of the operator S on the Internet (3) (S33). As described above, if the user ID is the mobile phone number, the user ID can be automatically notified by using a function of notifying a caller number.

The Web server (12) which received the price display request instructs the DB server (11) to search the price corresponding to the requested item identification code (S34).

Upon receiving this instruction, the DB server (11) searches the database (25) on the basis of the item identification code and the ID of the user A, extracts the requested price data (Step S35) and transmits the encrypted data to the user terminal (2A) (S36).

When the terminal (2A) downloads the encrypted data, the terminal reads out the secret key KA from the identification code storage portion (45) (S37), and decrypts the encrypted data by using this secret key KA (S38). Since this encrypted data is encrypted by using the secret key KA for the user A, the data can be returned to the original price data by the decryption processing (S38). By displaying this data on the screen of the display portion (46) (S39), the user A can check the actual price between parties (\480,000).

According to the present invention, it is only necessary for the operator S to print the URL of the price-proposing server managed by the operator S and the barcodes including the identification codes of the items in the goods catalog in addition to normal photos and prices. Since the barcodes do not include the prices between parties, they can be distributed to the general public.

On the other hand, the user can also read out the prices between parties for the user extremely easily by only reading out and accessing them by his/her own terminal registered in advance.

In the above-described embodiment, a catalog (100) is exemplified, but a medium for the electronic price-proposing system of the present invention may be any printed medium including fliers, ads in the paper/magazines and the like. Moreover, the barcodes may be displayed as an image with the goods in a shopping site on the Internet or may be displayed on a screen of broadcasting such as a TV commercial.

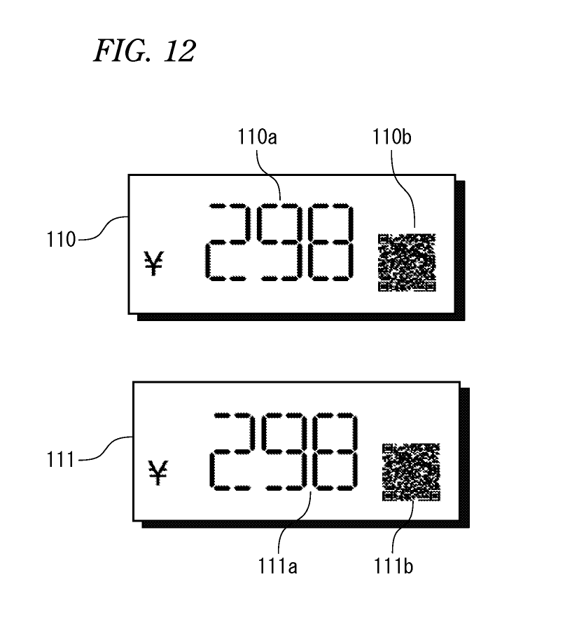

Moreover, the barcodes may be provided as price tags (110) and (111) at a storefront as illustrated in FIG. 12. In this configuration, the prices for general consumers are displayed in numerals (110a) and (111a) as before and two-dimensional barcodes (110b) and (111b) are also displayed close to them. The users who are offered special prices such as registered members can read out the two-dimensional barcodes (110b) and (111b) by their mobile phone terminals or the like and check the prices for themselves in advance. As a result, the differentiated prices for the specific members can be easily proposed while the special prices are hidden from the general consumers.

In the present invention, an access to the electronic price-proposing server may be made manually by a user to the URL registered in a bookmark or the like without necessarily executing the price link reading processing (S31). The identification code of an item may also be inputted manually from the operation portion (42) so as to obtain its price.

The price link means of the present invention is not limited to the above-described two-dimensional barcodes but may be one-dimensional barcodes or any display that can be read electronically. The price link reading portion is not limited to a camera, either, and may be any other means such as an optical reading sensor and a magnetic reading sensor.

A non-contact tag, for example, can be used as the price link means. In this case, an IC chip is embedded in the catalog or a price tag in advance so that the IC chip can be read out by using a known no-contact tag reading device.

As a method of updating the prices between parties, a price conversion value for updating the price to the user can be transmitted from the user terminal. For this price conversion value, a price conversion ratio for a change with a certain rate, a value for addition/subtraction in a batch, a calculation formula for updating the price on the basis of the identification code of an item and the like, for example, can be used.

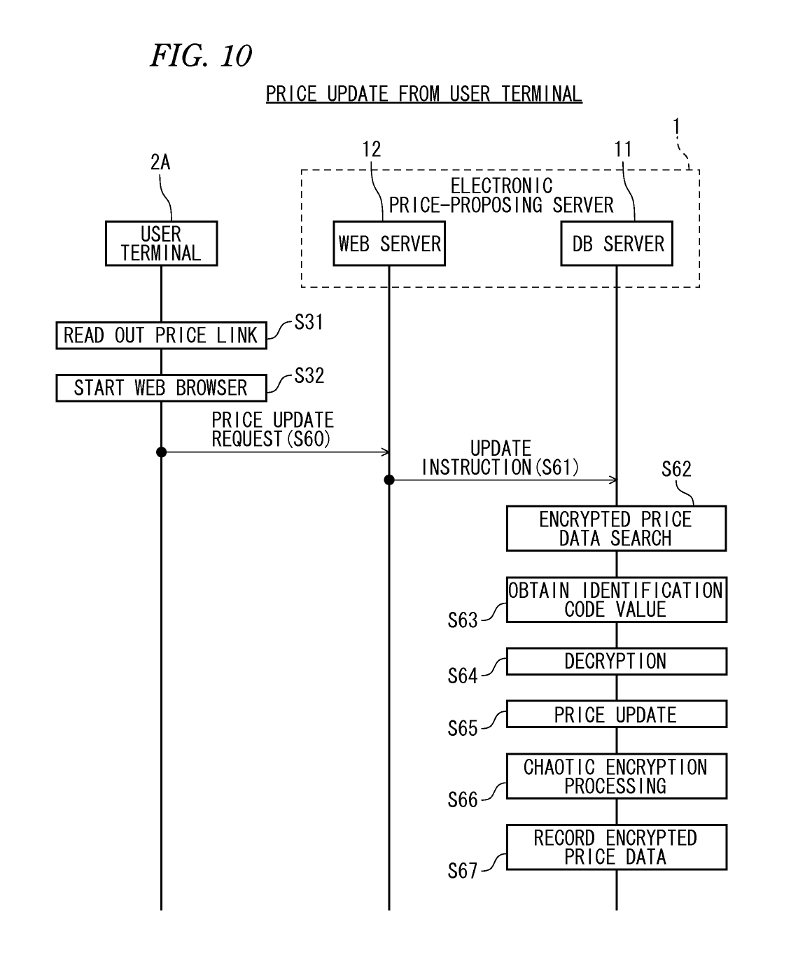

The update processing according to this technology is illustrated in FIG. 10.

First, the price link is read out (S31), and the Web browser is started (S32) and then, a price update mode, for example, is selected.

When a price update request (S60) including information of the item identification code and the price conversion value is sent to the Web server (12), the information is transmitted to the DB server (11) as an update instruction (S61).

The encrypted price data is searched in the DB server (11) (S62) by using the item identification code. Since the price data is encrypted in this state, the identification code value is read out from the database (25) on the basis of the ID of the user (S63) and is subjected to the decryption processing (S64) by the control portion (21) in accordance with the chaotic encryption method.

Then, the decrypted price is subjected to conversion processing (S65) in accordance with the above-described price conversion value. After that, the chaotic encryption processing (S66) and the encrypted price data recording (S67) are applied similarly to the processing procedure in FIG. 8.

According to the above-described method, the prices between parties can be easily updated from the user terminal. As a use method, a barcode which stores a price conversion value for applying discount is printed on a specific flyer and distributed, for example, so that if a user reads out the contents, the discount is applied to the user after that. If the information of the price conversion value having a deadline is stored, the discount can be applied only to those who have read the information within a specific period.

### Embodiment 2

In Embodiment 1, the configuration in which the price data stored in the database (25) is decrypted by the user terminal (2A) is described, but the decryption can be executed on the side of the electronic price-proposing server (1).

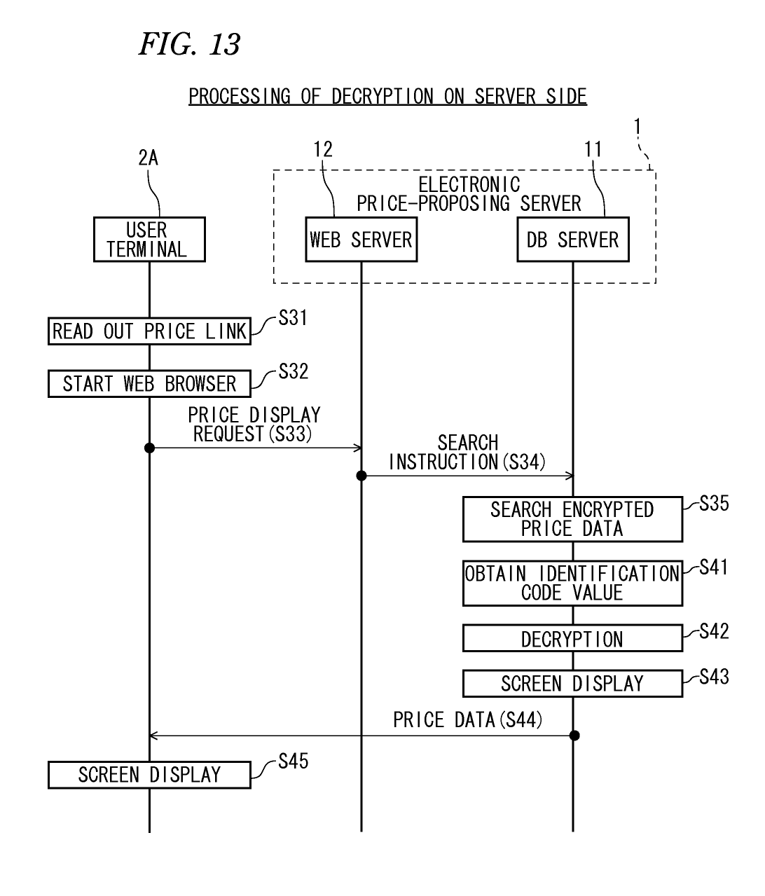

The flow of the processing in that case is illustrated in FIG. 13. The same processes as in FIG. 9 are given the same reference numerals, and the description will be omitted.

If a price display request (S33) is sent from the user terminal (2A), the search instruction (S34) is made to the DB server (11), and the encrypted price data is searched (S35) on the basis of the item identification code.

In this embodiment, the identification code value is read out (S41) from the database (25) on the basis of the ID of the user after that, and decryption processing (S42) is executed by the control portion (21) in accordance with the chaotic encryption method.

The price data subjected to the decryption processing and made readable may be displayed on the screen by the display portion (26) of the DB server (11). As an actual use method, there can be such an example that the display portion (26) is a display device of a price tag as illustrated in FIG. 12, and when the user terminal (2A) reads out the two-dimensional barcodes (110b) and (111b) and makes an access, the price display (110a) and (111a) is switched to the price between parties for some time.

In this case, if the user ID can be spoofed, the secrecy by the chaotic encryption method cannot be ensured sufficiently, but the identity of the user can be guaranteed by using the caller's number of a mobile phone, an IC tag distributed separately and the like as the ID. In this case, since the secrecy of the price between parties for each user is ensured in the database (25) of the server (1) by chaotic encryption, the electronic price data table can be freely distributed.

If an information amount of an electronic price list is additionally large, a process of compressing the data by a known technology may be added at the same time as encryption or communication of the electronic price data table. At this time, chaotic encryption may be executed by using a secret key of the operator S.

The decrypted price data can be transmitted to the user terminal (2A) to be displayed on the screen (S45).

In the present invention, an electronic price-proposing server may be provided as an electronic price-proposing device composed of a single body other than the electronic price-proposing system illustrated in FIG. 1. The present invention can be also provided as a processing method of the system.

Moreover, the present invention can be provided as a medium for an electronic price-proposing system such as the above-described catalog or price tag.

### Embodiment 3

In the present invention, the price data can be subjected to the encryption processing after being compressed. According to this method, data having a large capacity due to a large number of items and their prices between parties can be also stored in a recording medium having a small capacity. Moreover, if the data is to be stored in an electronic price-proposing server, amount of electricity used can be reduced, which contributes to space saving and power saving.

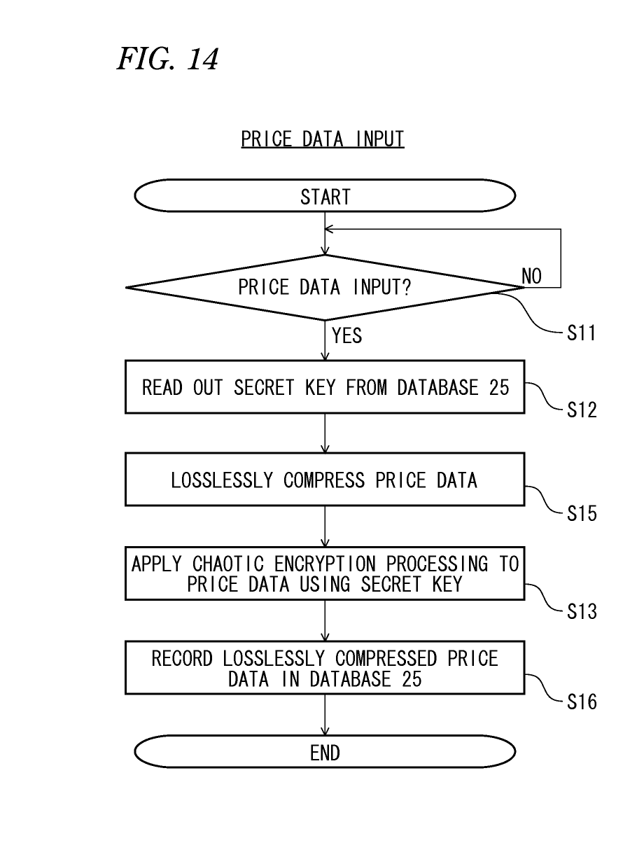

As illustrated in FIG. 14, after an instruction to input the price data is made (S11) in the price data input processing, the secret key is read out of the database (25). Then, the price data to be encrypted is compressed by using a lossless compression method (S15).

As the lossless compression method, any known methods can be used, but algorithms such as run-length encoding, Huffman encoding, LZW algorithm and the like are widely known. Compression methods such as LZW, LZH, ZIP using the LZW algorithm can be also used.

Subsequently, the compressed price data is subjected to chaotic encryption processing (S13).

By applying the encryption processing to the data whose capacity is made small, contribution can be made to less throughput and high-speed encryption.

Then, the price data which has been lossless compressed and encrypted is recorded in the database (25) (S16).

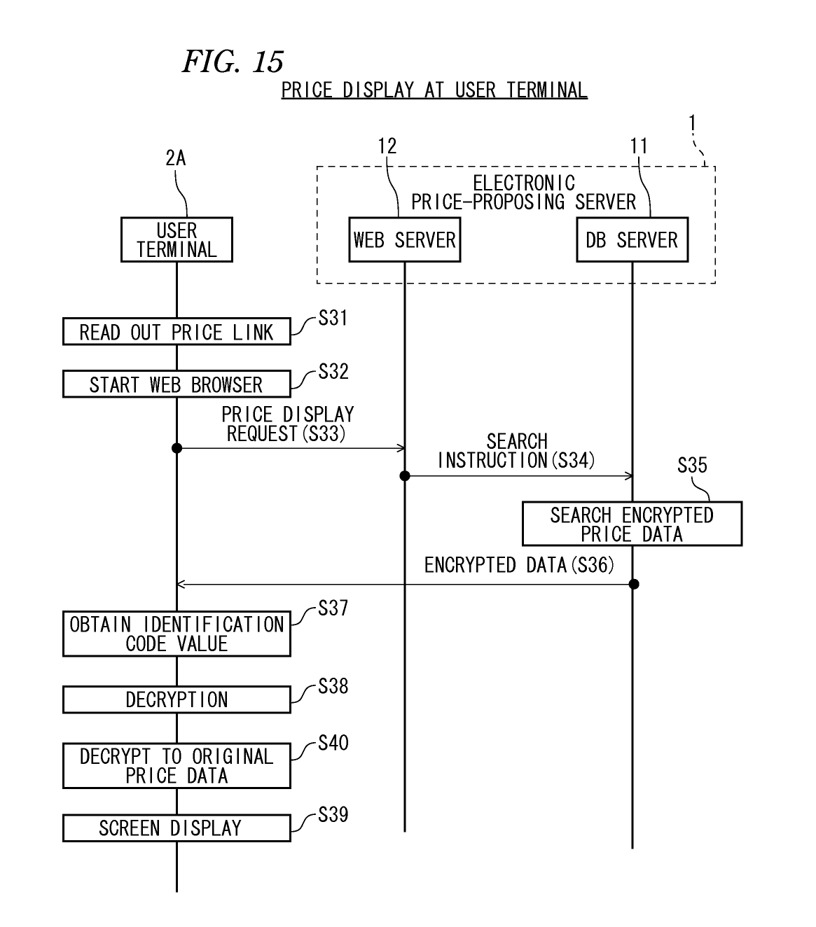

If the price is to be displayed at the user terminal, processing illustrated in FIG. 15 is executed.

The routine proceeds similarly to the processing illustrated in FIG. 9 up to decryption processing (S38), and then, the original price data is recovered (S40) by a reverse operation (decompression) of the lossless compression method. The result is displayed on the screen (S39).

The above-described method of using the compression/decompression process for the input and search of the price data can be similarly applied to the configuration of decryption on the server side illustrated in Embodiment 2. In this case, it is only necessary to include the above-described recovery process immediately after the decryption (S42) in FIG. 13.

### Embodiment 4

In the present invention, the search speed can be increased by using a hash function.

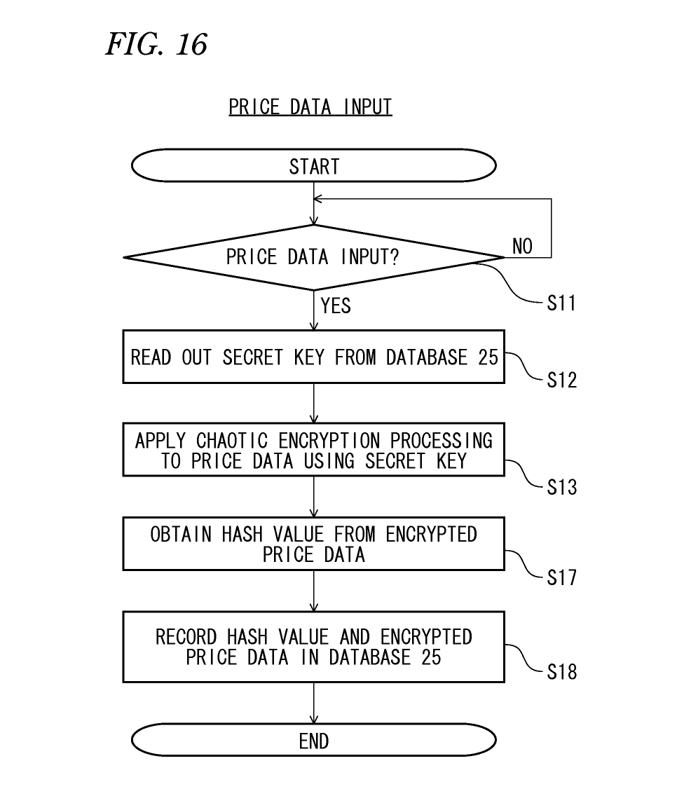

As illustrated in FIG. 16, in the price data input processing, the secret key is read out of the database (25) after an instruction of price data input is made (S11). Then, the chaos encryption processing is applied to the price data by using the secret key (S13).

Moreover, the encrypted N-dimensional data is hashed by using a predetermined hash function so as to acquire N pieces of hash values (S17).

These N pieces of hash values are associated with users and recorded as a hash table, and the hash values and the encrypted price data are stored in the database (25) (S18).

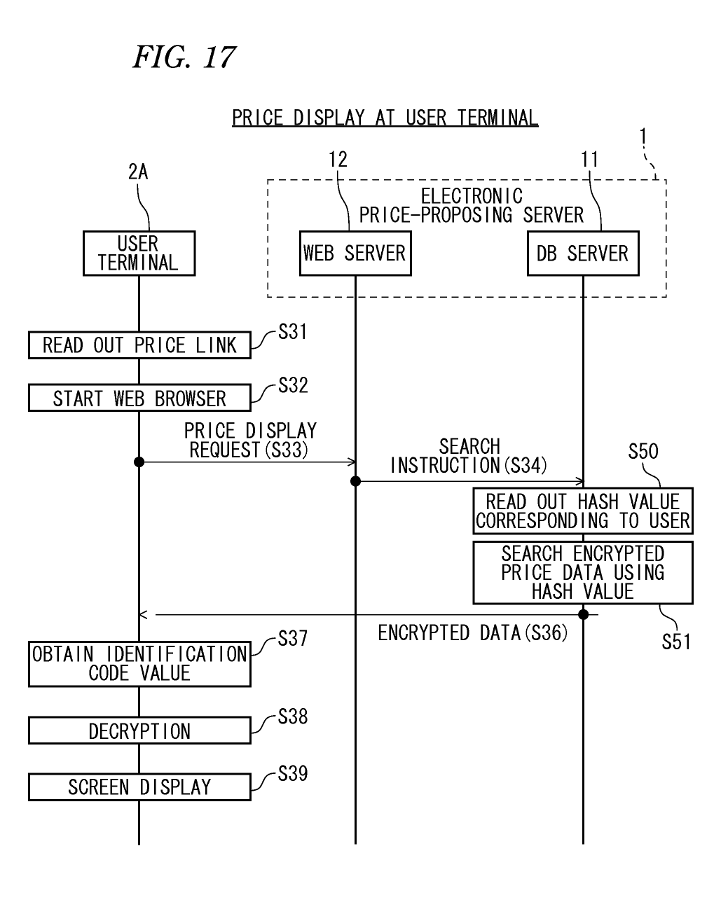

In the case of display of the price at the user terminal, if a search instruction (S34) is received in the DB server (11) as illustrated in FIG. 17, a hash value corresponding to the user is obtained (S50) from the hash table, and moreover, encrypted data is searched (S51) from the database (25).

The subsequent processing is the same as in Embodiment 1.

In Embodiment 2, too, it is only necessary to execute reading processing (S50) of the hash value and encrypted price data search processing (S51) by using the hash value instead of the encrypted price data search processing (S35).

### Embodiment 5

The method of updating the price between parties from the user terminal is illustrated in the above-described Embodiment 1. In this embodiment, a technology of batch update of the price by an administrator having a specific authority in the electronic price-proposing server (1) according to the present invention will be described.

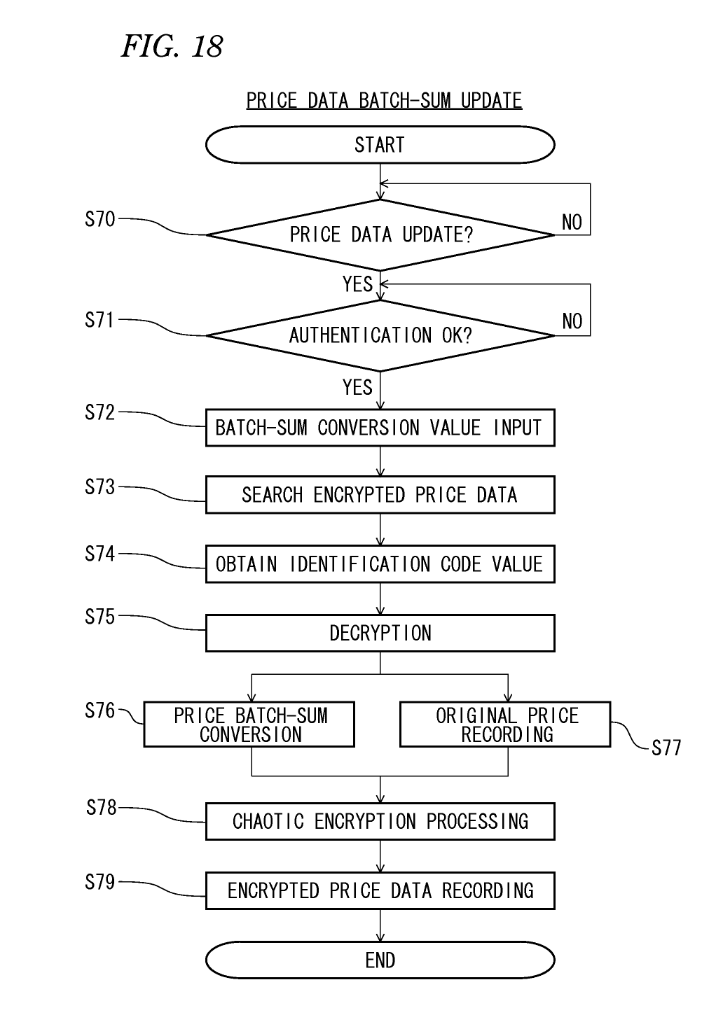

FIG. 18 illustrates a flowchart of this processing. First, the administrator selects processing of batch update of the price data (S70) from the input portion (22) in the DB server (11) of the electronic price-proposing server (1), and whether or not the administrator has a valid authority to update the price data is authenticated (S71). The authentication processing does not necessarily have to be executed, but since the identification code which becomes a secrete key is not used as in the above-described user terminal; the authentication processing is preferable in this embodiment.

If authenticated, the administrator inputs the batch conversion value (S72) from the input portion (22). As the batch conversion value, a price conversion ratio for a change with a certain rate, a value for addition/subtraction in a batch, a calculation formula for updating the price on the basis of the identification code of an item and the like can be used. Specifically, information such as “20% discount for all the goods”, “500 yen discount for all the goods” and the like is inputted. Conditions such as “1000 yen discount for all the items worth 10,000 yen or more and 3000 yen discount for all the items worth 20,000 yen or more” may be added depending on the current price.

Moreover, the batch conversion value can include information relating to a processing method of fractions. For example, the value can include information such as “round off to the nearest 1 yen”, “round off to the nearest 100 yen”, “round down to the nearest 100 yen”, “change all the digits less than 100 yen to 80” and the like.

search processing (S73) for the encrypted price data is executed. In the above-described embodiment, the price data is searched for each user, but since the entire price data is converted in a batch in this embodiment, the search processing (S73) is not executed, and all the stored data may be subjected to the search.

Then, the identification code values are read out (S74) on the basis of the user IDs corresponding to the encrypted price data searched or sequentially read out of the database (25) and are subjected to decryption processing (S75) by the control portion (21) in accordance with the chaotic encryption method.

The decrypted prices are subjected to the price batch conversion processing on the basis of the above-described batch conversion value (S76).

At the same time, the original price (initial price) before the conversion is recorded (S77) in the present invention. If the decrypted price of an item is 1000 yen and the batch conversion value is 30% discount, the price of the item is updated to 700 yen by the price batch conversion processing (S76), for example.

If the processing such as rounding off, rounding up or rounding down is not executed, the price can be reversibly returned to the original price by dividing 700 yen by 0.7 if the price is to be returned to a usual price. However, in the case of currency, it has the minimum unit all the time, and moreover, the fractions are set to 8 or 9 in order to have a round number of the sales price or to promote buying motivation in general. Thus, if such calculation is made, the price cannot be returned to the original price. A good example is that even though 30% discount of 1000 yen is 700 yen, 30% discount of 1001 yen and 999 yen is also 700 yen, and thus, an error might occur if this is changed to return the price to the original price or the rate is to be changed to 20% discount.

Therefore, processing of changing the previous price needs manual work one by one, and the work can sometimes last until midnight for the next business day. According to the present invention, the price can be easily returned to the price before conversion at any time by recording the initial price, and so price update work can be considerably reduced.

The batch converted price and the initial price are both encrypted and recorded in each of chaotic encryption processing (S78) and encrypted price data recording (S79) similarly to the processing procedure in FIG. 8. They can be executed in combination with the above-described configuration using lossless compression or the configuration using the hash value.

The recorded initial prices are used in the subsequent processing of price batch conversion. That is, if the administrator inputs “return to the initial price” or “update to 20% discount from the initial price” in the batch conversion value input (S72), the conversion is executed in the price batch conversion processing (S76) on the basis of the initial price, not on the basis of the current price (value that was previously batch converted). In the case of “return to the initial price”, it is only necessary to rewrite the current price to the recorded initial price, and in the case of the “update to 20% discount from the initial price”, it is only necessary to read out the initial price and to make calculation of 20% discount (and round-off and the like).

At this time, the initial price is newly recorded in initial price recording (S77) processing. That is, the original price is kept in the state in which the previous price is recorded all the time. By keeping the two prices all the time as above, temporary price conversion can be made easily.

Naturally, the processing to update the initial price may be provided in the batch conversion processing. In the case of this processing, the initial price cannot be recovered, but provision of this processing is effective if the initial prices are changed across the board by exchange rate fluctuation, for example.

### REFERENCE SIGNS LIST

1 electronic price-proposing server
2A user terminal A
2B user terminal B
2C user terminal C
3 internet

Thus, specific embodiments of an electronic price-proposing system, electronic price-proposing device, and electronic price-proposing method has been disclosed. It should be apparent, however, to those skilled in the art that many more modifications besides those described are possible without departing from the inventive concepts herein. The inventive subject matter, therefore, is not to be restricted except in the spirit of the appended claims.

1. An electronic price-proposing system comprising:
a user terminal held by each of a plurality of users and an electronic price-proposing server which proposes a price data corresponding to each user wherein the electronic price-proposing server comprises:
a secret-key recording means configured to record an identification code value which is either of an identification code uniquely assigned to each of a plurality of user terminals or a calculation value calculated in accordance with a predetermined calculation formula from the identification code in association as a secret key of each user;
an encrypting means configured to read out M pieces of the secret keys associated with each user from the secret-key recording means and to encrypt N pieces of the price data with respect to each item as one N-dimensional vector so as to generate an encrypted data by a chaotic encryption method in which N-dimensional, where N is a natural number, rational number vectors are encrypted at the same time by using M pieces, where M is a natural number, of the secret keys;
a price data recording means configured to chaotically encrypt the price data of the N pieces of items included in each column in a table-format price database in which each item is assigned to a row and each user is assigned to a column by using the identification code values of the M pieces of users assigned to each column and to record the price database in the table-format in a state encrypted by the identification code values according to each column;
a search means configured to search and read out the encrypted data of the price with respect to a target user of a target item from the price data recording means in accordance with a request from the user terminal;
a transmitting means configured to transmit the encrypted data read out by the search means to the user terminal;
the user terminal comprises:
an identification code value reading means configured to read out or calculate the identification code value;
a second transmitting means configured to transmit the request to the electronic price-proposing server;
a receiving means configured to receive the encrypted data transmitted from the electronic price-proposing server;
a decrypting means configured to decrypt the received encrypted data by using the identification code value read out of the identification code value reading means and generate original price data, and
a display means configured to display the decrypted price data.

2. An electronic price-proposing system according to claim 1 that further includes a decrypting means configured to decrypt the encrypted data read out by the search means by using the identification code value of the user read out of the secret-key recording means.

3. The electronic price-proposing system according to claim 1 wherein the electronic price-proposing system performs a lossless compresses the N pieces of the price data with respect to each item to one N-dimensional vector;
the encrypting means of the electronic price-proposing server encrypts the data as the N-dimensional vector and generates encrypted data, and
the decrypting means of the user terminal performs an operation opposite to the lossless compression after decryption and generates original price data.

4. The electronic price-proposing system according to claim 1 that further comprises:
a hash means configured to obtain and record N pieces of hash values by hashing the N-dimensional encrypted data encrypted by the encrypting means of the electronic price-proposing server by a predetermined hash function, and
the search means of the electronic price-proposing server searches and reads out the encrypted data recorded in association with the user from the price data recording means in accordance with the request from the user terminal by using the hash value recorded in association with the user as a keyword.

5. The electronic price-proposing system according to claim 1 wherein the electronic price-proposing system, price link means includes at least information of a network address of the electronic price-proposing server and an item identification code for identifying an item and is electronically readable by the user terminal;
the user terminal is provided with a price link reading means for reading the price link means;
a read-out item identification code is transmitted to a read-out network address from the second transmitting means, and
the search means of the electronic price-proposing server searches the encrypted data including the price data of the item corresponding to the received item identification code.

6. The electronic price-proposing system according to claim 5 wherein the second transmitting means transmits a price conversion value for updating the price in the price data together with the read-out item identification code, and
the electronic price-proposing server is provided with a price updating means for updating the price data with a result calculated on a basis of the price conversion value.

7. The electronic price-proposing system according to claim 5, wherein the price link means is barcode information and the price link reading means is a sensor for reading a barcode.

8. The electronic price-proposing system according to claim 5 wherein the price link means is a non-contact tag and the price link reading means is a non-contact tag reading means.

9. The electronic price-proposing system according to claim 5 that further includes a price link means including at least information of a network address of the electronic price-proposing server and an item identification code for identifying an item and electronically readable by the user terminal.

10. The electronic price-proposing system according to claim 9 wherein the price link means is barcode information.

11. The electronic price-proposing system according to claim 9 wherein the price link means is a non-contact tag.

12. The electronic price-proposing system according to claim 1 that further comprising:
an input means for inputting a batch price conversion value for updating the price in the price data in a batch, and
a batch price updating means for updating the price data with a result calculated on the basis of the batch price conversion value.

13. The electronic price-proposing system according to claim 11, wherein the batch price updating means uses an original price before update is recorded together with an updated price at the same time.

14. An electronic price-proposing device configured to propose a price corresponding to each of a plurality of users, comprising:
a secret-key recording means configured to record an identification code value which is either of an identification code uniquely assigned to each of a plurality of user terminals or a calculation value calculated in accordance with a predetermined calculation formula from the identification code in association as a secret key of each user;
an encrypting means configured to read out M pieces of the secret keys associated with each user from the secret-key recording means and to encrypt N pieces of the price data with respect to each item as one N-dimensional vector so as to generate an encrypted data by a chaotic encryption method in which N-dimensional, where N is a natural number, rational number vectors are encrypted at the same time by using M pieces, where M is a natural number, of the secret keys;
a price data recording means configured to chaotically encrypt the price data of the N pieces of items included in each column in a table-format price database in which each item is assigned to a row and each user is assigned to a column by using the identification code values of the M pieces of users assigned to each column and to record the table-format price database in a state encrypted by the identification code values according to each column;
a search means configured to search and read out the encrypted data of the price with respect to a target user of a target item from the price data recording means in accordance with a request from the user terminal, and
a transmitting means configured to transmit the encrypted data read out by the search means to the user terminal.

15. The electronic price-proposing device according to claim 14 wherein the price data recording means configured to chaotically encrypt the price data of the N pieces of items included in each column in a table-format price database in which each item is assigned to a row and each user is assigned to a column by using the identification code values of the M pieces of users assigned to each column and to record the price database in the table format in a state encrypted by the identification code values different according to each column.

16. The electronic price-proposing device according to claim 14 wherein the electronic price-proposing system performs a lossless compresses the N pieces of the price data with respect to each item to one N-dimensional vector;
the encrypting means of the electronic price-proposing server encrypts the data as the N-dimensional vector and generates encrypted data, and
the decrypting means of the user terminal performs an operation opposite to the lossless compression after decryption and generates original price data.

17. The electronic price-proposing device according to claim 14 further comprises:
a hash means configured to obtain and record N pieces of hash values by hashing the N-dimensional encrypted data encrypted by the encrypting means by a predetermined hash function, wherein
the search means searches and reads out the encrypted data recorded in association with the user from the price data recording means in accordance with a request from the user terminal by using the hash value recorded in association with the user as a keyword.

18. The electronic price-proposing device according to claim 14 that further comprises:
an input means for inputting a batch price conversion value for updating the price in the price data in a batch; and
a batch price updating means for updating the price data with a result calculated on the basis of the batch price conversion value.

19. The electronic price-proposing device according to claim 14, wherein the batch price updating means, uses an original price before update is recorded together with the updated price at the same time.

20. An electronic price-proposing method in an electronic price-proposing system composed of a user terminal held by each of a plurality of users and an electronic price-proposing server which proposes a price corresponding to each user comprising:
an encryption step in which an identification code value which is either of an identification code uniquely assigned to each of a plurality of user terminals in advance or a calculated value calculated in accordance with a predetermined calculation formula from the identification code is associated as a secret key of each user and recorded in the secret-key recording means of the electronic price-proposing server, and
an encrypting means of the electronic price-proposing server reads out M pieces of the secret keys associated with each of the users from the secret-key recording means and encrypts N pieces of the price data with respect to each of the items as a single N-dimensional vector so as to generate encrypted data by using the chaotic encryption method of encrypting an N-dimensional, where N is a natural number, rational number vector in a batch by using the M, where M is a natural number, pieces of the secret keys;
a price data recording step in which the price data recording means of the electronic price-proposing server chaotically encrypts the price data of the N pieces of items included in each column in a table-format price database in which each item is assigned to a row and each user is assigned to a column by using the identification code values of the M pieces of users assigned to each column and records the price database in the table format in a state encrypted by the identification code values different according to each column;
a request transmission step in which second transmitting means of the user terminal transmits a request to the electronic price-proposing server;
a search step in which search means of the electronic price-proposing server searches and reads out the encrypted data of the price with respect to a target user of a target item from the price data recording means in accordance with a request from the user terminal;
a transmission step in which the encrypted data read out by the search means is transmitted to the user terminal;
a reception step in which receiving means of the user terminal receives the encrypted data transmitted from the electronic price-proposing server;
an identification code value read-out step in which identification code value reading means of the user terminal reads out or calculates the identification code value;
a decryption step in which decrypting means of the user terminal decrypts the received encrypted data by using the identification code value read out of the identification code value reading means and generates original price data, and
a display step in which a display means of the user terminal displays the decrypted price data.

21. The electronic price-proposing method according to claim 21 that further includes a decryption step in which decrypting means of the electronic price-proposing server decrypts the encrypted data read out by this search means by using the identification code value of the user read out from the secret-key recording means.

22. The electronic price-proposing method according to claim 20 wherein the encryption step of the electronic price-proposing method performs a after lossless compression of N pieces of the price data with respect to each item to one N-dimensional vector, the encrypting means of the electronic price-proposing server encrypts the data as the N-dimensional vector and generates encrypted data, and
the decryption step, the decrypting means of the user terminal executes decryption and then, performs an operation opposite to the lossless compression and generates original price data.

23. The electronic price-proposing method according to claim 20 further comprises a step in which hashing means of the electronic price-proposing server hashes the N-dimensional encrypted data encrypted in the encryption step by a predetermined hash function so as to obtain and record N pieces of hash values is provided subsequent to the encryption step, and
the search step uses search means of the electronic price-proposing server to search and read out encrypted data recorded in association with the user from the price data recording means in accordance with a request from the user terminal by using the hash value recorded in association with the user as a keyword.

24. The electronic price-proposing method according to claim 20 that further includes a program for a server, characterized in that the electronic price-proposing method is executed by the electronic price-proposing server of a computer.

25. The electronic price-proposing method according to claim 20 that further includes a program for a terminal, characterized in that the electronic price-proposing method is executed by the user terminal of a computer.
